(19) United States
(12) Patent Application Publication
(10) Pub. No.: US 2013/0219826 A1
(43) Pub. Date: Aug. 29, 2013

(54) METHOD OF MANUFACTURING MULTIPURPOSE INTEGRATED BUILDING SYSTEMS AND BUILDING SYSTEMS PUT TOGETHER FROM STRIPS OF BAMBOO, METHOD OF MANUFACTURING STRIPS OF BAMBOO

(71) Applicants: Olivier Kracht, Chambourcy (FR); Jean Sébastien Lauffer, Damas Et Bettegney (FR)

(72) Inventors: Olivier Kracht, Chambourcy (FR); Jean Sébastien Lauffer, Damas Et Bettegney (FR)

(73) Assignee: LINEAZEN, Amiens (FR)

(21) Appl. No.: 13/883,680

(22) PCT Filed: Oct. 28, 2011
(86) PCT No.: PCT/FR2011/052527

§ 371 Date: May 6, 2013

(30) Foreign Application Priority Data
Nov. 4, 2010 (FR) 1059092

(51) Int. Cl. E04C 2/16; B27J 1/00; B32B 37/16

(52) U.S. Cl. CPC E04C 2/16; B32B 37/16; B27J 1/00
USPC 52/796.1; 156/60; 144/333

(57) ABSTRACT

A method of obtaining a multipurpose integrated building system made of bamboo includes the following steps: creating a stack of layers of strips of bamboo, a shape and volume of the stack being dependent on the shape and the volume desired for the building system; adding an adhesive; then pressing the stack. Elementary or complex building systems obtained using the method according to the invention are also disclosed. A disclosed method of manufacturing a bamboo strip involves the following steps: producing a longitudinal slit in a bamboo cane; softening the bamboo cane; opening and flattening the softened bamboo cane.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a method of manufacturing multipurpose integrated building systems based on bamboo, to the building systems obtained, using the method and to a method of manufacturing strips of bamboo. A multipurpose integrated building system here means a complex building system comprising structural elements that give the system its structural properties and elements that give the system other properties, for example thermal, acoustic, fire-retardant, esthetic, decorative, etc. properties.

2. Description of Related Art Including Information Disclosed Under 37 CFR 1.97 and 37 CFR 1.98

Bamboo is a grass used in many fields, including building. Bamboo canes have the shape of a hollow tube, of ring-shaped cross-section. It is thus known practice to make bamboo strips by crushing the bamboo. To do that, the bamboo canes are first of all treated and rid of potential defects, then slit lengthwise using a saw cut. The bamboo canes are then opened out mechanically either by hand or by machine. This method has the disadvantage of causing the bamboo to burst into narrow flakes of very uneven dimensions, leading to discontinuities in the material when the building systems are created by assembling several bamboo strips.

It is also known practice to “laminate” machined bamboo laminas to form parquet flooring or non-structural panels. To do that, the machined bamboo laminas are glued, then subjected to high pressures to form a bamboo agglomerate. The bamboo agglomerate is then cut and spliced to form the panels or beams with the desired dimensions. This method is costly and uses a significant amount of glue and of energy, and furthermore gives rise to significant wastage of material by comparison with bamboo in its original (cane) form.

It is also known practice to use glued wooden planks to create elementary building systems of substantially parallelepipedal overall shape, such as floors, posts or beams. More complex building systems can also be produced, by mechanically assembling elemental building elements. Thus there is knowledge as to how to create floors of cellular cross section by using screws or nails for example. However, the known methods involve numerous steps of preparing the basic material, namely the wooden planks. This is because wood has numerous defects (knots, etc.) which have to be removed by cutting the planks, removing the defective areas, splicing the planks together to obtain planks of uniform size, this being a notable cause of the significant material wastage.

### SUMMARY OF THE INVENTION

The invention proposes a new method for manufacturing elementary or complex (or integrated) building systems that makes it possible to create building systems that perform better than the equivalent known systems. The method according to the invention involves the following steps consisting in:
creating a stack of layers of bamboo strips, a shape and a volume of the stack being dependent on the desired shape and volume of the building system,
adding a glue, then
pressing the stack.

A bamboo strip here means a raw bamboo element obtained directly from bamboo canes, rather than an element reconstituted from elements such as chips glued together. Because the fibers of the bamboo canes are preserved, the bamboo strips used thus have the mechanical strength of the bamboo canes, which is far higher than the mechanical strength of a bamboo element that has been reconstituted from chips for example. The bamboo canes used have more or less the form of as plank, a length of which is great by comparison with the dimensions of the cross section of the bamboo strip. By way of example, the bamboo strips that can be used have a length of the order of 0.1 to 12 meters, a width of the order of 5 to 50 cm and a thickness of the order of 2 to 22 mm. The thickness of the bamboo strips is directly dependent on the thickness of the ring shape of a bamboo cane cross section.

Experience shows that bamboo canes with a ring-shaped cross section of a thickness (which means the distance between the two concentric circles that make up the ring) of 2 to 22 mm have good mechanical strength. The building systems obtained using the method according to the invention have the mechanical properties of the bamboo strips used, which are far superior to the mechanical properties of the glue.

The bamboo elements involved in the method may be of various kinds according to the needs of the elemental or complex systems aimed for. Note in particular the following bamboo raw materials:
bamboo strips obtained by the method according to the invention described hereinabove,
bamboos strips obtained by a known method involving opening the bamboo mechanically to obtain flattened bamboo,
raw or cut bamboo laths,
planed bamboo laminas used for an esthetic finish on building systems.

When creating the stack, the building system is prepared in such a way as to give it its final shape. Because the bamboo strips are slender, of the order of 2 to 22 mm, it is possible to produce very diverse shapes, shapes having straight edges (boards, posts, beams, rafters, etc.), but also more complex shapes, for example shapes having a rounded edge, a softened corner, a wavy edge or a wavy surface.

If necessary, in order to form the stack and hold it in position, the stack may be created in a mold of a shape and volume that are suited to the shape and volume of the building system that is to be produced. Likewise, if necessary, a step of planing the bamboo strips may be performed before the stacking step, in order to make the bamboo strips flatter.

The glue may be added between each layer of bamboo strips, between just some layers of bamboo, before the first layer of bamboo strips and/or after the last layer of bamboo strips.

In a method according to the invention, the pressing may be performed in several steps. In a preferred embodiment, a single pressing step is performed. Because the stack produced has the shape of the final building system, just one pressing step at the end is sufficient. The costs of manufacture are thus lower by comparison with the earlier methods. Any type of press can be used for the pressing. The pressing performed is preferably a three-dimensional pressing. The pressing may for example be performed using a press that allows vacuum bag pressing over the entire surface or using a press that presses at isolated spot locations using a pneumatic ram. Ideally, a press suited both to surface pressing and spot pressing allows a very wide variety of shapes to be achieved.

The method according to the invention makes it possible to create building systems the structural performance of which is particularly good by comparison with known equivalent wood systems, as will be seen better in the examples later on.

According to one embodiment of the method, during the stacking step, the bamboo strips of two adjacent layers of bamboo strips are laid in different directions. For example, the bamboo strips are aligned in a first direction in a first layer, then in a second direction in the second layer, and these two layers are then repeated until the desired thickness of the building system is achieved. In one example, the second direction is perpendicular to the first direction. In another example, the second direction is oblique to the first direction but not perpendicular. Three or more directions may also be envisioned. By crisscrossing the bamboo strips in this way, the mechanical performance of the building systems is enhanced and made more uniform in at least two directions. This is of particular interest for building systems that have at least two long dimensions, measuring of the order of several tens of centimeters to several meters, a floor or a wall for example.

According to one embodiment also, during the stacking step, one or more spacer piece(s) is (are) inserted between the bamboo strips at (a) predefined location(s). The number, material and shapes of the spacer pieces are selected according to the specific features (technical, esthetic, practical properties) desired for the building system.

According to an alternative form, after the pressing, step, the spacer piece is removed to leave an empty space at the predefined location. The spacer piece is, in this case, made of a material to which the glue will not stick. After the spacer piece has been removed, a complex building system is thus obtained that has empty spaces inside it, for example a honeycomb cross section. This makes it possible to lighten the complex system and/or to obtain thermal or acoustic properties that differ from those of a system of solid cross section. This also allows the user, at a later date, to fill the empty spaces with a material of his choice, according to the use being made of the building system. It is thus possible to fill the empty spaces with trunking for services or with materials that have particular thermal, acoustic, fire-retardant and/or esthetic properties (trunking for services for example).

According to another alternative form, the spacer piece is made of a material selected for its thermal, acoustic, fire-retardant, esthetic or other properties, and the spacer piece is not removed after pressing. The spacer piece thus forms an integral part of the building system and gives it particular thermal, acoustic, fire-retardant, esthetic or other properties. A multipurpose integrated building system ready for use is thus obtained.

The invention further relates to building systems obtained by the method described hereinabove and particular examples of which are described hereinbelow.

The invention also proposes anew method for obtaining bamboo strips that is more effective than the earlier method and comprises the following steps involving:
slitting the bamboo longitudinally.
softening the bamboo
opening the softened bamboo out flat.

Thus, using the method according to the invention, the bamboo fibers are no longer broken, there is less bursting, fewer empty spaces between the bamboo fibers in the bamboo strips resulting from the method according to the invention. The bamboo strips obtained are thus more dense, more uniform, offer better mechanical performance (bending strength, torsional strength, etc.) and better thermal and acoustic performance. Likewise, the bamboo strips obtained are more slender than planks of wood, improving on material usage.

There are various techniques that can be used for softening the bamboo. The bamboo may be heated and/or moistened, for example in an oven of controllable relative humidity. Chemical plasticizers may also be added to accelerate and facilitate the softening of the bamboo.

Raw bamboo canes overall have very few structural defects, and no defects of a size great enough to be troublesome to the manufacture of the planks. Cutting and splicing steps for eliminating defects are therefore not required. All of this further simplifies the production of the bamboo strips used for the manufacture of the building systems.

### BRIEF DESCRIPTION OF THE SEVERAL VIEWS OF THE DRAWINGS

The invention will be better understood, and other features and advantages of the invention will become apparent in the light of the following description of some examples of building systems obtained using a method according to the invention. These examples are given without any implied limitation. The description is to be read in conjunction with the attached drawings, in which:

FIGS. 1 to 5 show the cross sections of building systems according to the invention,

FIGS. 6 to 8 are views of profiles of building systems according to the invention.

### DETAILED DESCRIPTION OF THE INVENTION

As stated previously, the method according to the invention makes it possible to create from bamboo and in a simple way a very wide variety of elemental or complex building systems.

The building system is prepared entirely during a step of creating a stack of layers of bamboo strips; the shape and volume of the stack are dependent on the desired shape and volume of the building system. A glue is added, either after the stacking step or at successive intervals during the course of the stacking step. The stack is then pressed. Just one pressing step is performed, regardless of the envisioned shape of the building system. This is a significant difference between the method of manufacture according to the invention and the methods known from elsewhere.

If necessary, to make it easier to hold the bamboo strips and the spacer pieces in position during stacking, a mold of suitable shape and volume may be used.

The essential material for the manufacture of the building systems according to the invention is bamboo, used in the form of thin strips, of the order of 2 to 22 mm thick and of long length, of the order of 0 to 12 meters.

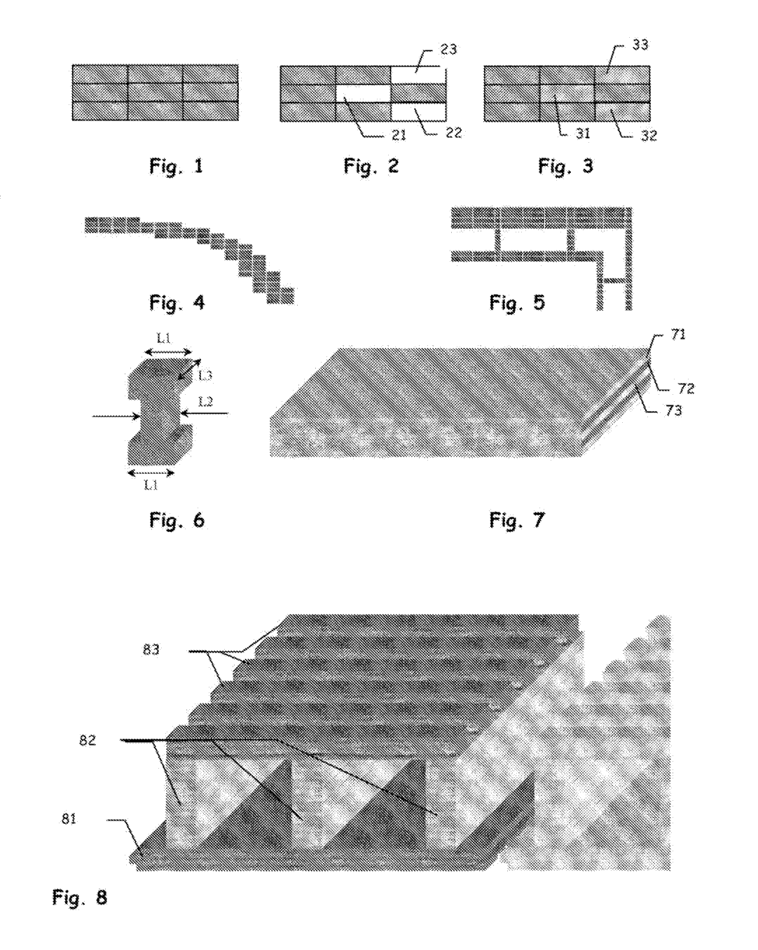

The bamboo strips and the spacer pieces are stacked in layers (FIGS. 1-8) before pressing, according to the desired properties of the building system. Highly diverse exterior shapes can be envisioned, other than parallelepipedal shapes, for example shapes having circular-arc-shaped edges (FIG. 4) or shapes having one or more corners (FIG. 3).

It is also possible to produce specific interior shapes by adding spacer pieces in between the bamboo strips.

In one alternative form, the spacer pieces are removed after pressing to leave empty spaces 21, 22, 23 inside the system (FIG. 2).

In another alternative form, the spacer pieces 31, 32, 33 are left inside the building system after pressing (FIG. 3) to obtain a complex building system incorporating materials with specific properties (thermal, acoustic, fire-retardant, esthetic, etc. properties).

The building systems obtained according to the method exhibit particularly advantageous structural performance, notably by comparison with equivalent wooden systems. For example, it is possible to create a bamboo beam 240 mm tall with a span of 6.97 m, for a total material volume of 0.0082 m³. A wooden beam with the same height of 240 mm has a maximum span of 6.33 m, for a total material volume of 0.0113 m³. The bamboo beam thus has a 10% greater span and a 40% lower material volume than a wooden beam of the same height. Stated differently, a bamboo beam has a smaller cross section than a wooden beam of the same length and the same bending strength. A reduction in cross section improves acoustic performance (the transmission of noise through material vibration is lower) and thermal performance (less thermal bridging).

FIG. 6 shows an I-section beam. Such a beam can be used to create floors or partitions for example. The beam is produced in one example by assembling:
several layers of bamboo strips, each layer havingseveral bamboo strips side by side so that the cross section of the layer has a length L1,
several layers of bamboo strips, each layer having several bamboo strips side by side so that the cross section of the layer has a length L2 less than L1, and
several layers of bamboo strips, each layer having several bamboo strips side by side so that the cross section of the layer has a length L1.

All the bamboo strips have the same length equal to the length L3 of the beam.

Just one single pressing step assembles the various layers of bamboo strips.

FIG. 7 shows a sheet intended for creating a facing of a structure such as a floor, a door panel, a wall filling panel, a work surface, etc., or more generally any element intended to work in compression. The sheet is made up of a succession of layers of bamboo strips. In two successive lavers 71, 72; 72, 73, the bamboo strips run in different. directions. On the sides of the sheet, grooves and/or tongues may be provided to make it easier at a later date to assemble several sheets (these have not been depicted).

By comparison with an equivalent sheet made of wood, the density of bamboo (which is higher than that of wood) contributes to improving the acoustic and thermal-inertia properties of the flooring system created. The comfort of the occupants in the building produced using bamboo sheets is therefore improved. The mechanical performance is also improved; by way of example:
a plywood beam with a cross section measuring 70 mm by 170 mm and a structural facing made of plywood 30 mm thick which have been mechanically assembled (using glue, nails, screws, etc.) can create a floor with a maximum span of 5.32 m,
a system according to the invention, comprising a bamboo beam with a cross section measuring 70 mm by 170 mm and a structural facing made of bamboo 30 mm thick, produced together using a method according to the invention, has a maximum span of 7.65 m,
this being an improvement in span of the order of 40%.

FIG. 8 shows a complex building system for creating a floor in a simple way. It is made up of, starting from the bottom of the figure:
a sheet 81 produced as a succession of layers of bamboo strips; in two successive layers, the bamboo strips run in different directions, along the sides of the sheet, grooves and/or tongues may be provided to make it easier at a later date to assemble several sheets,
on top of the sheet, beams 82 produced as narrow stacks of bamboo strips (one bamboo strip per layer in the example depicted), the bamboo strips all running in the same direction,
between the beams 82, spacer pieces are positioned in order to hold the elements in position during, the pressing step,
on top of the beams, reconstituted planks 83, produced as narrow stacks of bamboo strips, the reconstituted planks running in a direction perpendicular to the direction of the beams 82 on which they rest,
between the reconstituted planks, spacer pieces are positioned to maintain the separation between the reconstituted planks during the pressing step.

To create the system of FIG. 8, during the stacking step, spacer pieces have been positioned between the beams 82 and between the reconstituted planks 83, to keep the bamboo strips that form the beams 82 and the reconstituted planks 83 in position during the pressing step. In the example depicted, the spacer pieces have been removed after the pressing step. Spacer pieces could also have been produced in a material or materials that have specific thermal, acoustic or fire retardant properties, which are then left in place after the pressing step. The beams 82 provide the floor with bending strength, the bottom sheet 81 and the reconstituted planks 83 OR the top provide compression strength, allowing decorative coatings to be attached and also afford additional technical properties (protection against fire, acoustic properties, floor diaphragm, thermal properties, esthetic properties, for example). Just one single pressing step conglomerates the bamboo strips that make up the floor element.

1. A method of obtaining a building system, comprising the following steps:
creating a stack of layers of bamboo strips, a shape and a volume of the stack being dependent on the desired shape and volume of the building system,
adding a glue, then
pressing the stack.

2. The method as claimed in claim 1, in which, during the stacking step, the bamboo strips of two adjacent layers are laid in different directions.

3. The method as claimed in claim 1, in which, during the stacking step, a spacer piece is inserted between the bamboo strips at a predefined location.

4. The method as claimed in claim 3, in which, after the pressing step, the spacer piece is removed to leave an empty space at the predefined location.

5. The method as claimed in claim 3, in which the spacer piece is made of a material selected for its thermal, acoustic, fire-retardant, esthetic or other properties.

6. The method as claimed in claim 1, in which the bamboo strips have a thickness of between 2 and 22 mm.

7. A building system, characterized in that it is obtained by a method as claimed in claim 1.

8. The building system as claimed in claim 7, of which a cross section in a plane perpendicular or oblique to a longitudinal dimension of bamboo strips has an edge of straight or circular-arc or angled overall shape.

9. The building system as claimed in claim 7, of the post or beam type, of solid cross section.

10. The system as claimed in claim 9, of rectangular, lozenge, I-shaped, O-shaped or L-shaped cross section.

11. The building system as claimed in claim 7, comprising the superposition of:
a first sheet made of several layers of bamboo strips the orientation of which alternates from one layer to the next,
one or more bamboo beams laid in the direction to the first sheet, the bamboo beams being made up of a stack of bamboo strips and a space between the beams being left empty or filled with a material other than bamboo, and
a second sheet made up of several layers of bamboo strips the orientation of which alternates from one layer to the next.

12. A method of manufacturing a bamboo strip, comprising the following, steps, involving:
slitting the bamboo longitudinally,
softening the bamboo, and
opening the softened bamboo out flat.

13. The method as claimed in claim 12, in which the bamboo is softened by heating, moistening and/or the addition of chemical plasticizers.
